(19) United States
(12) Patent Application Publication
(10) Pub. No.: US 2020/0376931 A1
(43) Pub. Date: Dec. 3, 2020

(54) VEHICLE AIR EXTRACTOR AND PRESSURE RELEASE METHOD

(71) Applicant: Ford Global Technologies, LLC, Dearborn, MI (US)

(72) Inventors: Scott Christopher Sterbenz, Brownstown, MI (US); Eric Jay MacLean, Brighton, MI (US)

(21) Appl. No.: 16/427,901

(22) Filed: May 31, 2019

(51) Int. Cl. B60H 1/24

(52) U.S. Cl. CPC B60H 1/249

(57) ABSTRACT

An air extractor assembly includes, among other things, a housing, a first valve, and a second valve. The first valve is coupled to the housing and configured to transition from a sealed position to a pressure releasing position in response to a first pressure differential. The second valve is coupled to the housing and configured to transition between a sealed position and a pressure releasing position in response to a second pressure differential that is different than the first pressure differential.

### TECHNICAL FIELD

This disclosure relates generally to an air extractor for a vehicle.

### BACKGROUND

Vehicles can include an air extractor. Flow can move through an opening in the air extractor, as required, to release pressure inside a passenger compartment of the vehicle to an area outside the vehicle. The air extractor can be located, for example, behind a bumper at a rear of the vehicle.

### SUMMARY

An air extractor assembly according to an exemplary aspect of the present disclosure includes, among other things, a housing, a first valve, and a second valve. The first valve is coupled to the housing and configured to transition from a sealed position to a pressure releasing position in response to a first pressure differential. The second valve is coupled to the housing and configured to transition between a sealed position and a pressure releasing position in response to a second pressure differential that is different than the first pressure differential.

In a further non-limiting embodiment of the foregoing air extractor, the first valve is a first umbrella valve, and the second valve is second umbrella valve.

In a further non-limiting embodiment of any of the foregoing air extractors, a maximum diameter of the first umbrella valve is greater than a maximum diameter of the second umbrella valve.

In a further non-limiting embodiment of any of the foregoing air extractors, the first umbrella valve includes a stem extending from an enlarged head to a flap. The enlarged head is disposed on a first side of the housing. The flap disposed on an opposite, second side of the housing.

In a further non-limiting embodiment of any of the foregoing air extractors, the stem extends through a bore in the housing, and at least one aperture is distributed circumferentially about the bore.

In a further non-limiting embodiment of any of the foregoing air extractors, the first valve is configured to transition from the sealed position to the pressure releasing position relative to at least one first aperture of the housing. The second valve is configured to transition from the sealed position to the pressure releasing position relative to at least one second aperture of the housing.

In a further non-limiting embodiment of any of the foregoing air extractors, the at least one aperture provides a total open area in the housing that is greater than a total open area provided by the at least one second aperture.

In a further non-limiting embodiment of any of the foregoing air extractors, the first valve in the sealed position permits less flow through the at least one first aperture than the first valve in the pressure releasing position. The second valve in the sealed position permits less flow through the at least one second aperture than the second valve in the pressure releasing position.

In a further non-limiting embodiment of any of the foregoing air extractors, the first valve in the sealed position permits nominally no flow through the at least one first aperture. The second valve in the sealed position permits nominally no flow through the at least one second aperture.

In a further non-limiting embodiment of any of the foregoing air extractors, the first and second pressure differentials are differences between a pressure on a first side of the housing and a pressure on an opposite, second side of the housing.

In a further non-limiting embodiment of any of the foregoing air extractors, the second valve is configured to stay in the sealed position in response to the first pressure differential. The first valve is configured to stay in the sealed position in response to the second pressure differential.

A further non-limiting embodiment of any of the foregoing air extractors includes a plurality of the first valves coupled to the housing, and a plurality of the second valves coupled to the housing.

An air extractor assembly, according to yet another exemplary aspect of the present disclosure includes, among other things, a housing, and a first valve coupled to the housing. The first valve has a flap with a first maximum diameter. A second valve is coupled to the housing. The second valve has a flap with second maximum diameter that is greater than the first maximum diameter. The first and second valves are each configured to transition from a sealed position to a pressure releasing position in response to a common pressure differential.

A vehicle pressure release method according to still another exemplary aspect of the present disclosure includes, among other things, in response to a first pressure differential, moving a first valve from a sealed position with a housing to a pressure releasing position. The method further includes, in response to a different, second pressure differential, moving a second valve from a sealed position with the housing to a pressure releasing position.

In a further non-limiting embodiment of the foregoing method, the first and second pressure differentials are differences between a pressure within a passenger compartment of a vehicle and a pressure outside the vehicle.

In a further non-limiting embodiment of any of the foregoing methods, the first valve is a first umbrella valve, and the second valve is second umbrella valve.

In a further non-limiting embodiment of any of the foregoing methods, a maximum diameter of the first umbrella valve is greater than a maximum diameter of the second umbrella valve.

A further non-limiting embodiment of any of the foregoing methods includes permitting less flow through at least one first aperture of the housing when the first valve in the sealed position than when the first valve is in the pressure releasing position. The method further includes permitting less flow through at least one second aperture of the housing when the second valve in the sealed position than when the second valve is in the pressure releasing position.

A further non-limiting embodiment of any of the foregoing methods includes permitting nominally no flow through the at least one first aperture when the first valve is in the sealed position, and permitting nominally no flow through the at least one second aperture when the second valve is in the sealed position.

In a further non-limiting embodiment of any of the foregoing methods, a total open area provided by the at least one first aperture is greater than a total open area provide by the at least one second aperture.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of a portion of a vehicle with a bumper removed to reveal an air extractor according to an exemplary aspect of the present disclosure.

FIG. 2 illustrates a schematic view of the air extractor having both a first valve and a second valve in sealed positions, which blocks contaminants from entering a passenger compartment of a vehicle.

FIG. 3 illustrates a schematic view of the air extractor having the first valve in a pressure releasing position, which permits flow to move from the passenger compartment to balance a pressure in the passenger compartment with a pressure outside the vehicle, and the second valve in the sealed position.

FIG. 4 illustrates a schematic view of the air extractor having both the first valve and the second valve in pressure releasing positions, which permits flow to move from the passenger compartment to balance a pressure in the passenger compartment with a pressure outside the vehicle.

FIG. 5 illustrates a close-up front view of the air extractor of FIG. 1.

FIG. 6 illustrates a rear view of the air extractor of FIG. 1.

FIG. 7 illustrates a section view at line 7-7 in FIG. 5 showing first valves of the air extractor in sealed positions.

FIG. 8 shows the first valves from the section view of FIG. 7 in pressure releasing positions.

### DETAILED DESCRIPTION

This disclosure details an exemplary air extractor that includes valves. The valves can be umbrella valves, for example. The valves can transition from a sealed position to a pressure releasing position in response to different pressure differentials.

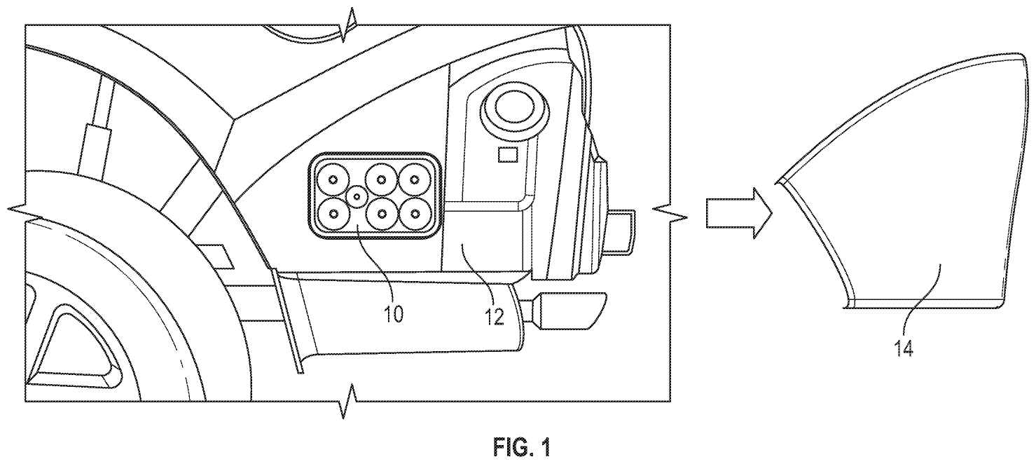

With reference to FIG. 1, a vehicle includes an air extractor 10 mounted, in the exemplary embodiment, to a vehicle body panel 12 and behind a bumper 14. One air extractor 10 is shown, but the vehicle could include a plurality of the air extractors 10—one on the passenger side and one on the driver side, for example.

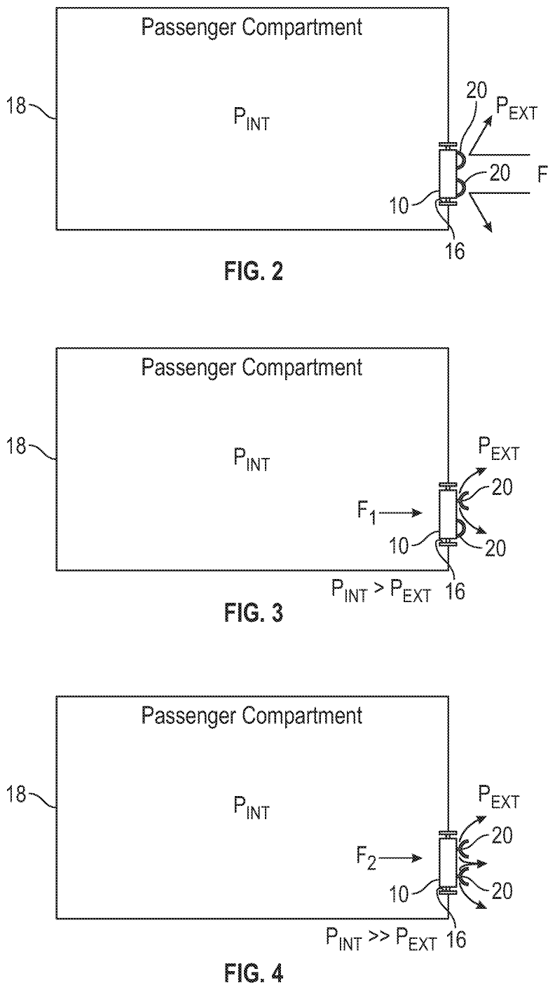

With reference now to FIGS. 2-5, the air extractor 10 is disposed within an opening 16 extending from a passenger compartment 18 of the vehicle to an area surrounding the vehicle. The air extractor 10 includes first and second valves 20.

In FIG. 2, the first and second valves 20 of the air extractor 10 are in sealed positions where the first and second valves 20 block flow F from moving through the opening 16 into the passenger compartment 18. Flow F moving from outside the vehicle, through the opening 16, and into the passenger compartment 18 could include contaminants, such as dust, odors, etc. The first and second valves 20 are in the sealed position when a pressure P_{INT} within the passenger compartment 18 is substantially equal to a pressure P_{EXT} outside the vehicle.

In FIG. 3, the pressure P_{INT} within the passenger compartment 18 has increased to be greater than the pressure P_{EXT} such that there is a first pressure differential between the passenger compartment 18 and the area outside the vehicle. The increase in the pressure P_{INT} could be due to a user activating the air conditioning system, closing a door, etc.

The first pressure differential forces one of the valves 20 of the air extractor 10 to transition to a pressure releasing position where a first flow F₁ of air can move from the passenger compartment 18, through the air extractor 10, to the outside of the vehicle. Permitting the flow F₁ to move from the passenger compartment 18 can lower the pressure P_{INT}. The valves 20 are biased toward the sealed position, such that the one of the valves 20 returns to the sealed position of FIG. 2 when the pressure P_{INT} is no longer forcing the one of the valves 20 into the pressure releasing position. Releasing pressure within the passenger compartment 18 can help to reduce door closing efforts, for example.

In FIG. 4, the pressure P_{INT} has increased to be greater than the pressure P_{EXT} such that there is a second pressure differential between the passenger compartment 18 and the area outside the vehicle. The second pressure differential is greater than the first pressure differential. The relative increase in the pressure P_{INT} could be due to, for example, the user slamming, rather than softly closing, a door of the vehicle.

The second pressure differential forces both the valves 20 to transition to a pressure releasing position where a second, greater flow F₂ of air can move from the passenger compartment 18, through the air extractor 10, to the outside of the vehicle. Permitting the flow F₂ to move from the passenger compartment 18 can lower the pressure P_{INT}. Again, the valves 20 are biased toward the sealed position, such that the valves 20 return to the sealed position of FIG. 2 when the pressure P_{INT} is no longer forcing the valves 20 into the pressure releasing position.

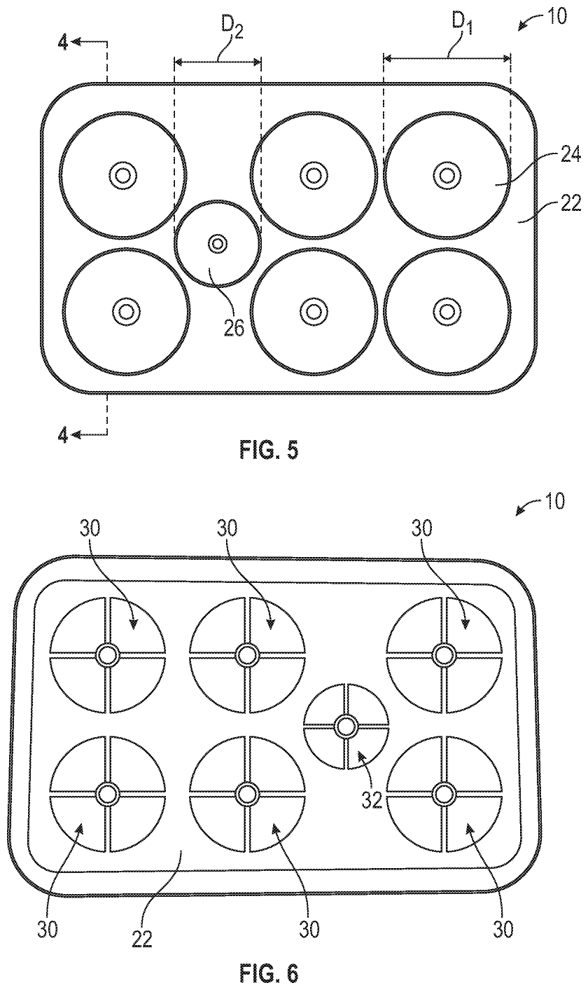

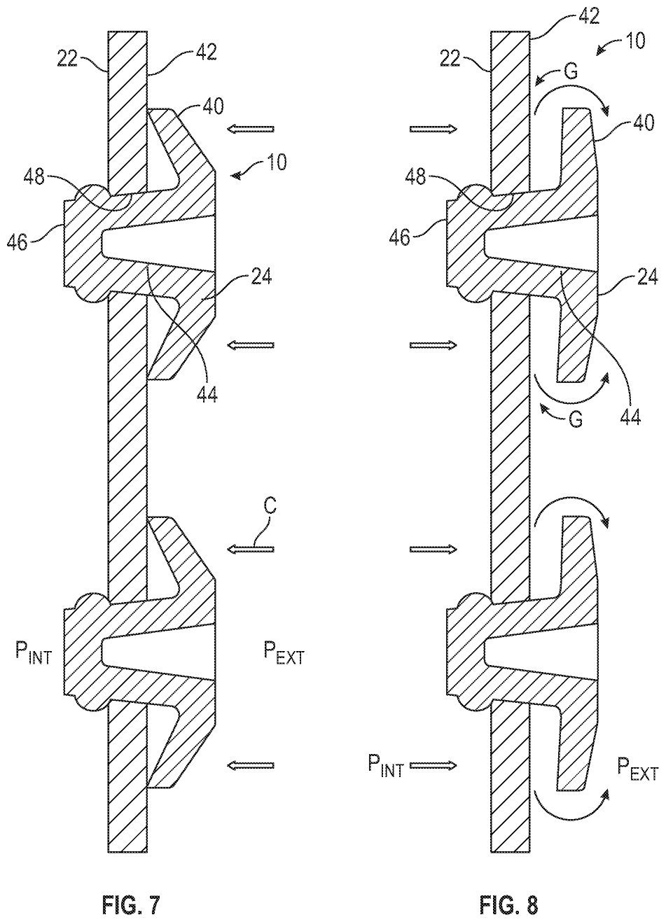

Referring now to FIGS. 5-8, in an exemplary embodiment, the air extractor 10 includes a housing 22. The valves 20 of the air extractor 10 are provided by at least one first umbrella valve 24, and at least one second umbrella valve 26. The valves 20 could be other types of valves in other examples.

In the exemplary embodiment, a diameter D₁ of the first umbrella valve 24 is greater than a diameter D₂ of the second umbrella valve 26. Also, the first umbrella valve 24 is made of the same material as the second umbrella valve 26, and the relative thicknesses of the first umbrella valve 24 are similar to the relative thicknesses in the second umbrella valve 26. In the exemplary embodiment, the second umbrella valve 26 is essentially a scaled down version of the first umbrella valve 24.

The exemplary air extractor 10 includes six of the first umbrella valves 24 and one of the second umbrella valves 26. Other numbers of first umbrella valves 24 and second umbrella valves 26 could be used in other examples.

The first umbrella valves 24 are each biased toward a sealed position where the first umbrella valves 24 blocks flow through a respective group of first apertures 30. The at least one second umbrella valve 26 is biased toward a sealed position where the second umbrella valve 26 blocks flow through a respective group of second apertures 32. The total open area provided by each of the groups of first apertures 30 is greater than the total open area provide by the group of second apertures 32.

The first umbrella valves 24 and the second umbrella valves 26 are each in sealed positions in FIGS. 5-7. When the umbrella valves 24, 26 are in the sealed positions, the umbrella valves 24, 26 maintain a concave relationship relative to the housing 22. Further, when the umbrella valves 24, 26 are in the sealed positions, a flap 40 of each of the umbrella valves 24, 26 presses against a face 42 of the housing 22 to block flow through the respective group of the first apertures 30 or second apertures 32. In the sealed positions, the flaps 40 block nominally all flow through the respective group of the first apertures 30 or second apertures 32 Each of the flaps 40 are sized such that a diameter of the flaps 40 is just larger than a diameter of the respective group of the first apertures 30 or second apertures 32 that the flap is intended to cover to block flow.

In the exemplary embodiment, the flaps 40 directly contact the face 42, which is planar. In another exemplary embodiment, a raised rib could extend circumferentially about the respective openings. The flap 40 could touch off against the raised rib when in the sealed position to provide a knife-edge seal. The knife-edge seal may provide a more effective seal than the umbrella valve simply sealing against a planar surface of the housing 22. A raised rib could instead or additionally extend from an underside of the flap 40 toward the housing 22.

The umbrella valves 24, 26 include a stem portion 44 extending from the flap 40 to an enlarged head 46. The flap 40 and the enlarged head 46 are on opposite sides of the housing 22 to hold the respective umbrella valve 24, 26 relative to the housing 22.

During assembly, the enlarged head 46 can be inserted into an aperture 48 of the housing 22. The enlarged head 46 is compressed when moving through the aperture 48. When the enlarged head 46 reaches the opposite side of the housing 22, the enlarged head 46 can expand to hold the umbrella valve 24, 26 relative to the housing 22.

The umbrella valves 24, 26 are silicone in this example. In other examples, the umbrella valves could be rubber or neoprene. The housing 22 can be injection molded from a polymer-based material.

FIG. 8 shows a condition where the pressure P_{INT} has increased above a threshold value. This pressure differential is applying a force to an underside of the flap 40 that moves the flap 40 away from the face 42 to create a gap G between the flap 40 and the housing 22.

Flow moves through the gap G until the difference between the pressure P_{INT} and the pressure P_{EXT} has been reduced. At that point, the force provided by the pressure differential is no longer sufficient to move the flaps 40 away from the face 42. The flaps 40 then move back against the face 42 to seal the first apertures 30.

Since the size of the umbrella valve 24 differs from the sizes of the umbrella valves 26, the force required to move the flap of the umbrella valve 24 away from the face 42 differs from the force required to move the flaps 40 of the umbrella valves 26 away from the face 42.

Thus, when smaller pressure differentials exist, the second umbrella valve 26 may move to the pressure releasing position to provide pressure balancing while the first umbrella valves 24 remain in sealed positions.

A greater difference between the pressure P_{INT} and the pressure P_{EXT} can cause all the umbrella valves 24, 26 to move to pressure releasing positions. This can increasing a total area available for flow through the housing 22 when compared to moving only the second umbrella valve 26 to the pressure releasing position.

In the exemplary embodiment, the umbrella valves 24, 26 move to the pressure releasing positions at different threshold pressure differentials due to the difference in the diameters of the first umbrella valve 24 and the second umbrella valve 26.

In other examples, material compositions of valves of an air extractor could be varied relative to each other to cause the valves to transition from sealing positions to pressure releasing positions at different threshold pressure differentials. At least one first umbrella valve could be made of a stiffer material than at least one second umbrella valve, for example.

In still other examples, thicknesses of valves could be varied relative to each other to cause the valves to transition from sealing positions to pressure releasing positions at different threshold pressure differentials. At least one first umbrella valve could have a thicker flap than the flap of at least one second umbrella valve, for example.

As an example, the umbrella valves 24, 26 could be configured to transition from a sealed position to a pressure releasing position in response to a common pressure differential. That is, even though the diameter D₁ of the umbrella valves 24 is greater than a diameter D₂ of the umbrella valve 26, the umbrella valves 24, 26 could be made of different material compositions. Since a material composition of the umbrella valves 26 is different than a material composition of the umbrella valve 24, the umbrella valves 24, 26 transition from a sealed position to a pressure releasing position in response to the same (i.e., a common) pressure differential. The umbrella valves 24, 26 could instead or additionally be have different thickness so that the umbrella valves 24, 26 transition from a sealed position to a pressure releasing position in response to the same pressure differential.

Size, material composition, thicknesses, etc. of valves within an air extractor could be adjusted independently from one another or in some combination to provide valves that transition from sealing positions to pressure releasing positions at different threshold pressure differentials.

Using both larger and smaller valves, such as in the exemplary embodiment of FIGS. 5-8, can facilitate packaging due to, among other things, the ability to nest the smaller valves within open areas between the larger valves. Depending on packaging around the air extractor, the positions of the valves can be altered to avoid obstructions, such as a body structure protruding in front of a corner of the air extractor. Further, to accommodate an amount of flow that the air extractor may be required to accommodate, using only a single umbrella valve would result in an umbrella valve that only opened with the pressure differential was very high.

Although a specific component relationship is illustrated in the figures of this disclosure, the illustrations are not intended to limit this disclosure. In other words, the placement and orientation of the various components shown could vary within the scope of this disclosure. In addition, the various figures accompanying this disclosure are not necessarily to scale, and some features may be exaggerated or minimized to show certain details of a particular component.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. An air extractor assembly, comprising:
a housing;
a first valve coupled to the housing and configured to transition from a sealed position to a pressure releasing position in response to a first pressure differential; and
a second valve coupled to the housing and configured to transition from a sealed position and a pressure releasing position in response to a second pressure differential that is different than the first pressure differential.

2. The air extractor assembly of claim 1, wherein the first valve is a first umbrella valve, and the second valve is second umbrella valve.

3. The air extractor assembly of claim 2, wherein a maximum diameter of the first umbrella valve is greater than a maximum diameter of the second umbrella valve.

4. The air extractor assembly of claim 2, wherein the first umbrella valve includes a stem extending from an enlarged head to a flap, the enlarged head disposed on a first side of the housing, the flap disposed on an opposite, second side of the housing.

5. The air extractor assembly of claim 4, wherein the stem extends through a bore in the housing, and at least one aperture is distributed circumferentially about the bore.

6. The air extractor assembly of claim 1, wherein the first valve is configured to transition from the sealed position to the pressure releasing position relative to at least one first aperture of the housing, wherein the second valve is configured to transition from the sealed position to the pressure releasing position relative to at least one second aperture of the housing.

7. The air extractor assembly of claim 6, wherein the at least one aperture provides a total open area in the housing that is greater than a total open area provided by the at least one second aperture.

8. The air extractor assembly of claim 6, wherein the first valve in the sealed position permits less flow through the at least one first aperture than the first valve in the pressure releasing position, wherein the second valve in the sealed position permits less flow through the at least one second aperture than the second valve in the pressure releasing position.

9. The air extractor assembly of claim 8, wherein the first valve in the sealed position permits nominally no flow through the at least one first aperture, wherein the second valve in the sealed position permits nominally no flow through the at least one second aperture.

10. The air extractor assembly of claim 1, wherein the first and second pressure differentials are differences between a pressure on a first side of the housing and a pressure on an opposite, second side of the housing.

11. The air extractor assembly of claim 1, wherein the second valve is configured to stay in the sealed position in response to the first pressure differential, wherein the first valve is configured to stay in the sealed position in response to the second pressure differential.

12. The air extractor assembly of claim 1, further comprising a plurality of the first valves coupled to the housing, and a plurality of the second valves coupled to the housing.

13. An air extractor assembly, comprising:
a housing;
a first valve coupled to the housing, the first valve having a flap with a first maximum diameter; and
a second valve coupled to the housing, the second valve having a flap with second maximum diameter that is greater than the first maximum diameter, wherein the first and second valves are each configured to transition from a sealed position to a pressure releasing position in response to a common pressure differential.

14. A vehicle pressure release method, comprising:
in response to a first pressure differential, moving a first valve from a sealed position with a housing to a pressure releasing position; and
in response to a different, second pressure differential, moving a second valve from a sealed position with the housing to a pressure releasing position.

15. The vehicle pressure release method of claim 14, wherein the first and second pressure differentials are differences between a pressure within a passenger compartment of a vehicle and a pressure outside the vehicle.

16. The vehicle pressure release method of claim 14, wherein the first valve is a first umbrella valve, and the second valve is second umbrella valve.

17. The vehicle pressure release method of claim 16, wherein a maximum diameter of the first umbrella valve is greater than a maximum diameter of the second umbrella valve.

18. The vehicle pressure release method of claim 14, further comprising permitting less flow through at least one first aperture of the housing when the first valve in the sealed position than when the first valve is in the pressure releasing position, and permitting less flow through at least one second aperture of the housing when the second valve in the sealed position than when the second valve is in the pressure releasing position.

19. The vehicle pressure release method of claim 18, further comprising permitting nominally no flow through the at least one first aperture when the first valve is in the sealed position, and permitting nominally no flow through the at least one second aperture when the second valve is in the sealed position.

20. The vehicle pressure release method of claim 18, wherein a total open area provided by the at least one first aperture is greater than a total open area provide by the at least one second aperture.
